(19) United States
(12) Patent Application Publication
(10) Pub. No.: US 2015/0378856 A1
(43) Pub. Date: Dec. 31, 2015

(54) STORAGE SYSTEM, STORAGE DEVICE, CONTROL METHOD AND CONTROL PROGRAM OF STORAGE DEVICE, MANAGEMENT DEVICE, AND CONTROL METHOD AND STORAGE MEDIUM

(71) Applicant: NEC CORPORATION, Minato-ku, Tokyo (JP)

(72) Inventor: Satoshi YAMAKAWA, Tokyo (JP)

(73) Assignee: NEC CORPORATION, Minato-ku, Tokyo (JP)

(21) Appl. No.: 14/768,026

(22) PCT Filed: Feb. 25, 2014
(86) PCT No.: PCT/JP2014/054566

§ 371 Date: Aug. 14, 2015

(30) Foreign Application Priority Data
Feb. 26, 2013 (JP) 2013-036088

(51) Int. Cl. G06F 11/20; G06F 3/06

(52) U.S. Cl. CPC G06F 11/2069; G06F 3/0619; G06F 3/065; G06F 3/0683; G06F 2201/805

(57) ABSTRACT

Convenience of data access is to be secured. A storage system includes two or more storage devices that store original data or copy data of the original data, and a management device that identifies a first storage device for storing the original data and a second storage device for storing the copy data. The storage devices each include two or more data storage units different in accessibility, a data copy control unit that controls generation of the copy data, an access frequency control unit that pseudo-conforms the access frequency to the copy data to the access frequency to the original data, and a data storage location control unit that determines the storage location of the original data and the copy data based on the access frequency and accessibility.

### TECHNICAL FIELD

### Incorporation by Reference

The present invention claims priority based on Japanese Patent Application No. 2013-036088 filed on Feb. 26, 2013, the entire content of which is incorporated hereinto by reference.

The present invention relates to a storage system, a storage device, a control method and a control program of the storage device, a management device, and a control method and a control program of the management device

### BACKGROUND ART

Distributed storage systems are known that include a plurality of storage devices connected to each other via a network, and cause the storage devices to perform as a single storage device. The distributed storage system is easy to expand the system scale, because the system scale can be expanded simply by adding a storage device.

In addition, in the distributed storage system a plurality of duplicate data may be respectively stored in different storage devices. In this case, for example in case that one of the storage devices has failed, the data can be retrieved from another storage device. Accordingly, the distributed storage system has higher reliability in terms of data preservation, compared with the case where the data is concentratedly preserved in a single storage device. For example, Patent Literature (PTL) 1 discloses a technique of virtualizing a plurality of disk storage devices for integrated management of the storage devices.

Further, the accessibility to the storage unit containing data varies depending on the type of the storage unit. For example, a solid state drive (SSD) generally has higher accessibility than a hard disk drive (HDD). In addition, a dynamic random access memory (DRAM) has higher accessibility than the SSD, though the DRAM is unable to permanently preserve the data. For example, PTL 2 discloses a technique of changing the storage unit in which data is to be stored depending on access frequency.

### CITATION LIST

### Patent Literature

PTL 1: Japanese Patent Application Laid-Open Publication No. 2008-065561

PTL 2: Japanese Patent Application Laid-Open Publication No. 2010-108341

### SUMMARY OF INVENTION

### Technical Problem

The disclosure of the cited literature is incorporated hereinto by reference. The following analysis has been made from the viewpoint of the present invention.

As stated above, a plurality duplicate data may be respectively stored in different storage devices. In this case, it is preferable that the user can access the duplicate data without uncomfortable feeling, even when the storage device storing original data has failed. In other words, it is preferable that the convenience in accessing the data is kept from being degraded even when the storage device storing original data has failed.

The technique disclosed in PTL 1 makes no reference to the convenience in accessing the data in case that the storage device storing original data has failed. Here, it will be assumed that the storage unit storing duplicate data has low accessibility than the storage unit storing the original data. In such a case, the convenience in accessing the data may be degraded in case that the storage device storing original data has failed, with the technique according to PTL 1.

In addition, PTL 2 makes no reference to the reliability of data preservation. Therefore, the access to the data is disabled in case that the storage device storing the data has failed, with the technique according to PTL 2.

Accordingly, the present invention provides a storage system, a storage device, a control method and a control program of the storage device, a management device, and a control method and a control program of the management device that contribute to securing convenience in accessing the data.

### Solution to Problem

A storage system according to a first aspect of the present invention includes

two or more storage devices that store original data and duplicate data of the original data; and

a management device that identifies a first the storage device that stores the original data and a second the storage device that stores the duplicate data. The storage devices each is provided with:

two or more data storage units different in accessibility from each other;

a data duplication control unit that controls generation of the duplicate data;

an access frequency control unit that pseudo-conforms access frequency to the duplicate data to access frequency to the original data; and

a data storage location control unit that determines storage locations of the original data and the duplicate data based on the access frequency and the accessibility.

A storage device according to a second aspect of the present invention includes:

two or more data storage units different in accessibility from each other;

a data duplication control unit that controls duplication of data;

an access frequency control unit that pseudo-conforms access frequency to the duplicate data to access frequency to the original data; and

a data storage location control unit that determines respective storage locations of the original data and the duplicate data of the original data based on the access frequency and the accessibility.

A control method of a storage device according to a third aspect of the present invention is provided. The storage device includes two or more data storage units different in accessibility from each other. The control method includes:

a data duplication control step;

an access frequency control step of pseudo-conforming access frequency to the duplicate data to access frequency to the original data; and

a data storage location control step of determining respective storage locations of the original data and the duplicate data of the original data based on the access frequency and the accessibility.

Note that the method is related to the specified device such as the data storing storage device.

A control program according to a forth aspect of the present invention is provided. The control program causes a computer that controls a storage device including two or more data storage units different in accessibility from each other to execute:

a data duplication control process;

an access frequency control process for pseudo-conforming access frequency to the duplicate data to access frequency to the original data; and

a data storage location control process for determining respective storage locations of the original data and the duplicate data of the original data based on the access frequency and the accessibility.

A management device according to a fifth aspect of the present invention includes:

a management device storage unit that stores a storage device management rule in which a data ID, original data storage location information, and duplicate data storage location information are associated with one another; and

a management device control unit that identifies a first storage device for storing original data and a second storage device for storing duplicate data, in accordance with the storage device management rule.

A management device control method according to a sixth aspect of the present invention includes:

a storage step of storing a storage device management rule in which a data ID, original data storage location information, and duplicate data storage location information are associated with one another; and

a management device control step of identifying a first storage device for storing original data and a second storage device for storing duplicate data, in accordance with the storage device management rule.

A management device control program according to a seventh aspect of the present invention is provided. The management device control program causes a computer that controls a management device to execute:

a storage process for storing a storage device management rule in which a data ID, original data storage location information, and duplicate data storage location information are associated with one another; and

a management device control process for identifying a first storage device for storing original data and a second storage device for storing duplicate data, in accordance with the storage device management rule.

The program according to the fourth and seventh aspects may be recorded on a computer-readable storage medium. In this case, non-transient storage medium such as a semiconductor memory, a hard disk, a magnetic recording medium, and an optical recording medium may be employed. The present invention may also be realized as a computer program product.

### Advantageous Effects of Invention

With the foregoing aspects of the present invention, a storage system, a storage device, a control method and a control program of the storage device, a management device, and a control method and a control program of the management device that contribute to securing convenience in accessing the data can be obtained.

### BRIEF DESCRIPTION OF DRAWINGS

FIG. 1 is a block diagram for explaining an overview of an exemplary embodiment.

FIG. 2 is a block diagram showing an example of an overall configuration of a storage system 1 according to a first exemplary embodiment.

FIG. 3 is a block diagram showing an example of an internal structure of a management device 2.

FIG. 4 is a block diagram showing an example of an internal structure of a storage device 3.

FIG. 5 is a table showing an example of a storage device management rule.

FIG. 6 is an example of a storage location management table.

FIG. 7 is a flowchart showing an example of a data storing operation.

FIG. 8 is a block diagram showing an example of a data storage arrangement.

FIG. 9 is a flowchart showing an example of a data readout operation.

FIG. 10 is a flowchart showing an example of a process of pseudo-conforming the access frequency.

FIG. 11 is a flowchart showing an example of a decision process on whether the storage device 3 has failed.

FIG. 12 is a flowchart showing an example of an operation performed in case of failure of an original data storage device 32.

FIG. 13 is a flowchart showing an example of an operation performed in case of failure of a storage device 501.

FIG. 14 is a flowchart showing an example of an operation performed by a client computer 4.

### DESCRIPTION OF EMBODIMENTS

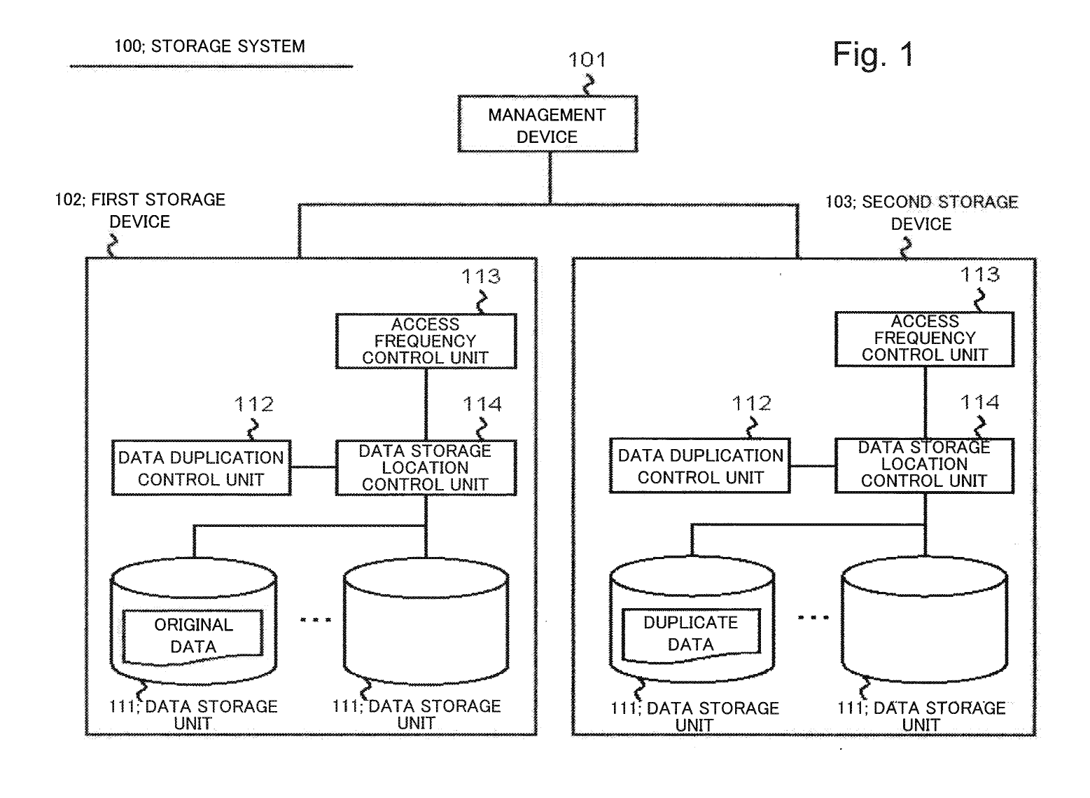

First, the overview of an exemplary embodiment will be described with reference to FIG. 1. The reference numerals given to constituents in the drawings are merely for the sake of convenience and clarity, and the description given hereunder is in no way intended to limit the present invention.

As stated above, a storage system is desired that contributes to securing the convenience in accessing data.

Accordingly, a storage system 100 shown in FIG. 1 is provided as an example. The storage system 100 includes two or more storage devices and a management device 101. More specifically, the storage system 100 includes a first storage device 102 that stores original data and a second storage device 103 that stores duplicate data. The management device 101 identifies the first storage device 102 and the second storage device 103.

The storage devices each include two or more data storage units 111, a data duplication control unit 112, and a data storage location control unit 114.

The data storage units 111 each store data, and are different in accessibility from each other. The data duplication control unit 112 controls generation of duplicate data. The access frequency control unit 113 pseudo-conforms the access frequency to the duplicate data to the access frequency to the original data. The data storage location control unit 114 determines the storage location of the original data and the duplicate data based on the access frequency and the accessibility. To be more detailed, the data storage location control unit 114 determines the data storage unit 111 of appropriate accessibility as storage location of the data, based on the access frequency to the data. For example, the data storage location control unit 114 may determine the data storage location so as to store the more frequently accessed data in the data storage unit 111 having higher accessibility.

The data duplication control unit 112 generates the duplicate data for use as substitute data for the original data. Accordingly, the user does not have to access the duplicate data unless the first storage device 102 suffers a malfunction. However, the access frequency control unit 113 of the second storage device 103 pseudo-increases the access frequency to the duplicate data each time the original data is accessed, despite the duplicate data not being accessed.

Therefore, the data storage location control unit 114 of the second storage device 103 can determine the storage location of the duplicate data based on the same criteria as the storage location of the original data. Consequently, the storage system 100 can maintain equilibrium between the accessibility to the storage location of the original data and the accessibility to the storage location of the duplicate data.

In the storage system 100, therefore, the accessibility to the data can be kept from being degraded even when the user accesses the duplicate data because of a malfunction of the first storage device 102. As a result, the storage system 100 can contribute to securing the convenience in accessing the data.

Hereunder, more specific exemplary embodiments will be described in further details, with reference to the drawings. When the original data and the duplicate data are referred to in a pair in the description given hereunder, it is to be assumed that the duplicate data is a reproduction from the corresponding original data.

### First Exemplary Embodiment

Referring to the drawings, a first exemplary embodiment will be described in further details.

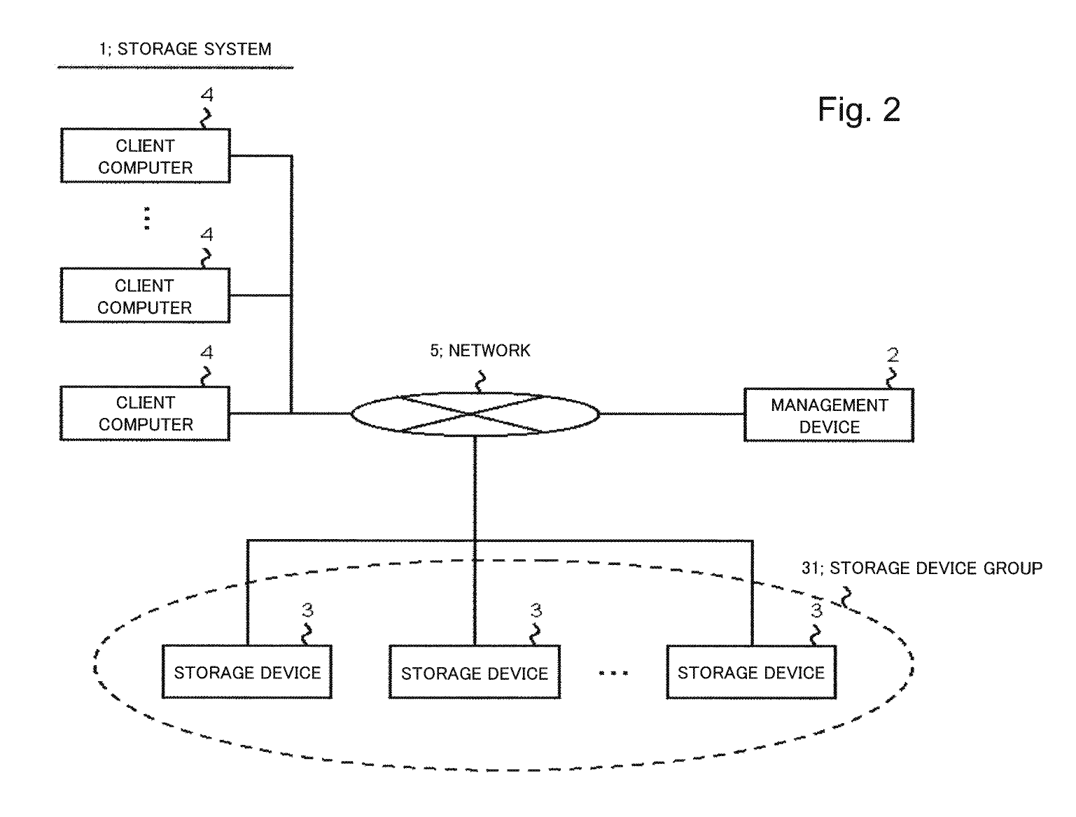

FIG. 2 is a block diagram showing an example of an overall configuration of the storage system 1 according to this exemplary embodiment. The storage system 1 includes a management device 2, a storage device group 31 including two or more storage devices 3, and one or a plurality of client computers 4. The storage devices 3, the management device 2, and the client computers 4 are communicable with each other via a network 5. In the following description, the storage device 3 that stores the original data (corresponding to the first storage device 102) will be referred to as original data storage device 32. In addition, in the following description the storage device 3 that stores the duplicate data (corresponding to the first storage device 103) will be referred to as duplicate data storage device 33.

The management device 2 monitors the operational status of the storage device 3. The management device 2 also identifies the original data storage device 32 and the duplicate data storage device 33 in accordance with a predetermined rule (hereinafter, storage device management rule). The details of the storage device management rule will be subsequently described.

The storage devices 3 each memorize and store data. More particularly, the original data storage device 32 writes and reads out the data in accordance with a request of the client computer 4. The duplicate data storage device 33 memorizes and stores the duplicate data of the original data.

The client computer 4 transmits a data writing request and a data readout request to the storage device 3. The client computer 4 can also access the data stored in the storage device 3.

The network 5 may be realized based on a protocol such as a fiber channel protocol (FCP), a fiber channel over Ethernet (FCoE, registered trademark), Infini Band, and TCP/IP on the Ethernet. However, the network 5 may be realized in different manners.

The internal structure of the management device 2 will be described hereunder.

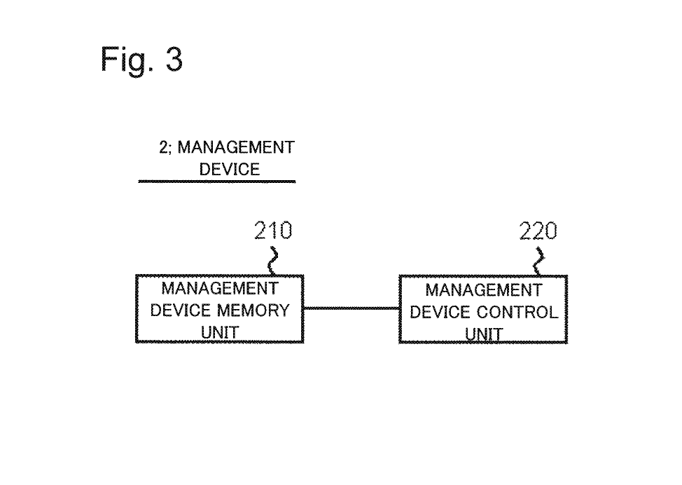

FIG. 3 is a block diagram showing an example of the internal structure of the management device 2. The management device 2 includes a management device memory unit 210 and a management device control unit 220. For the sake of simplicity, FIG. 3 primarily illustrates a module associated with the management device 2 according to this exemplary embodiment.

The management device memory unit 210 stores information necessary for the operation of the management device 2. For example, the management device memory unit 210 stores the storage device management rule.

Here, the storage device management rule is constituted of information including data ID, original data storage location information, and duplicate data storage location information associated with one another. The storage device management rule may be a table in which the data ID, the original data storage location information, and the duplicate data storage location information are associated with one another.

The data ID stands for a number or the like allocated to each piece of data. The original data storage location information stands for information for identifying the storage device 3 that is the storage location of the original data. The duplicate data storage location information stands for information for identifying the storage device 3 that is the storage location of the duplicate data. The original data storage location information and the duplicate data storage location information may be an address allocated to each of the storage devices 3.

The duplicate data storage location information may also include a priority order of each of the duplicate data (hereinafter, data priority). In this case, it is preferable that the data of a higher priority is stored in the storage device 3 having higher accessibility.

Here, the term “accessibility” means an index for evaluating the data writing and reading performance. The accessibility may be evaluated based on, for example, input/output per second (IOPS) indicating the number of writing and reading times that can be executed per second, throughput indicating the capacity that can be processed per second, and response time. Although various accessibility evaluation methods are available, the method is not specifically limited in the present invention.

The management device control unit 220 identifies the storage location of the original data and the storage location of the duplicate data, in accordance with the storage device management rule. The management device control unit 220 then notifies the storage device management rule to the storage devices 3 and the client computers.

Further, the management device control unit 220 monitors the operational status of the storage devices 3. To be more detailed, the management device control unit 220 decides whether the storage device 3 has a malfunction depending on whether communication with the corresponding storage device 3 can be made. Upon deciding that the storage device 3 has failed, the management device control unit 220 isolates the storage device 3 from the storage system 1. More specifically, the management device control unit 220 modifies the storage device management rule so as to exclude the storage device 3 that has failed from the original data storage location information and the duplicate data storage location information. The details of the operation to be performed when the storage device 3 has failed will be subsequently described.

The internal structure of the storage device 3 will now be described.

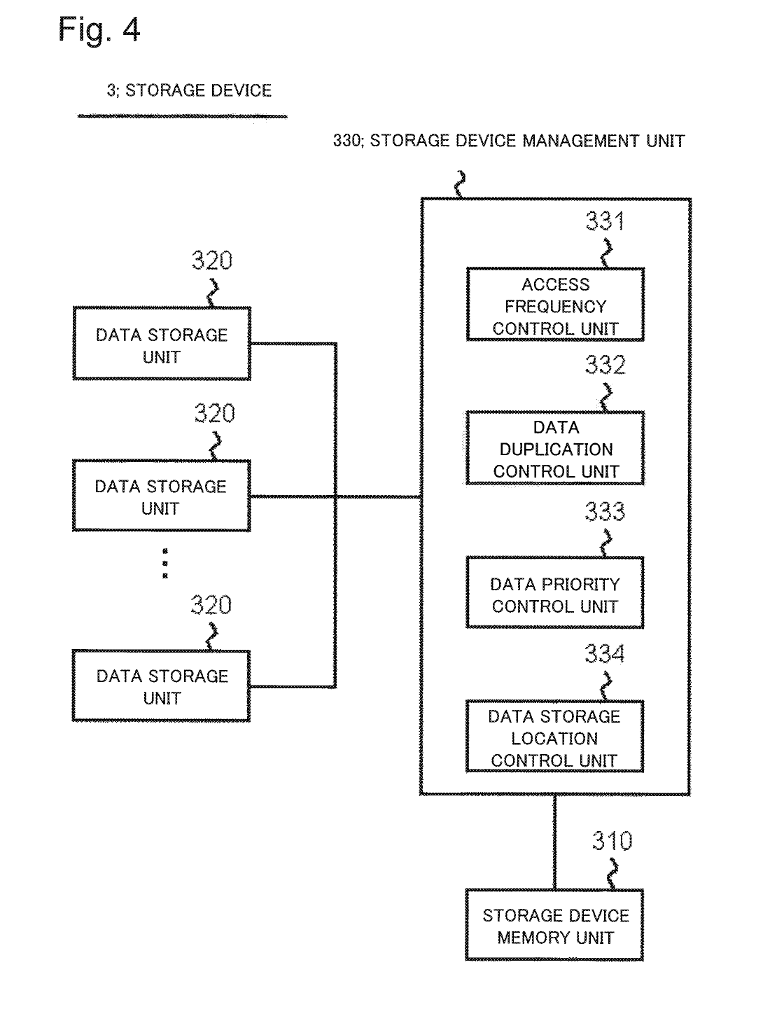

FIG. 4 is a block diagram showing an example of the internal structure of the storage device 3. The storage devices 3 includes a storage device memory unit 310, two or more data storage units 320, and a storage device management unit 330. The storage device management unit 330 includes an access frequency control unit 331, a data duplication control unit 332, a data priority control unit 333, and a data storage location control unit 334. For the sake of simplicity, FIG. 4 primarily illustrates a module associated with the storage device 3 according to this exemplary embodiment.

The storage device memory unit 310 stores information necessary for causing the storage device 3 to operate. For example, when the management device 2 notifies the storage device management rule to the storage device 3, the storage device memory unit 310 stores the storage device management rule.

The storage device memory unit 310 also stores a storage location management table in which the data ID, the data priority, and the data storage location identifying information are associated with one another. The data storage location identifying information refers to information to be used to identify the data storage location inside the storage device 3. More specifically, it is preferable that the storage device memory unit includes information for identifying the data storage unit 320 (hereinafter, data storage unit identifying information) and the address at which the data is stored inside the data storage unit 320 (hereinafter, data storage location address).

The data storage unit 320 may be, for example, a HDD, a SSD, a DRAM, a resistance random access memory (ReRAM), and a phase change random access memory (PRAM). In addition, the storage device 3 may include three types of data storage units 320 respectively having the accessibility of a first place, a second place, and a third place as classified below, the first place being the highest. Here, the classification given below is in no way intended to limit the configuration of the data storage unit 320. Further, the type of the data storage unit 320 is not specifically limited.

First place: Volatile device such as DRAM, or non-volatile ReRAM, PRAM though slower than DRAM

Second place: SSD incorporated with flush memory

Third place: HDD

The storage device management unit 330 manages the data storage location inside the storage device 3. The storage device management unit 330 also responds to the data access request from the client computer 4.

The access frequency control unit 331 controls the number of accesses and the access frequency to the storage device 3. To be more detailed, the access frequency control unit 331 increments the number of accesses upon receipt of a data readout request or a data update request. In addition, the access frequency control unit 331 calculates the access frequency from the number of accesses per unit time.

More specifically, the access frequency control unit 331 of the original data storage device 32 increments the number of accesses each time a data readout request is received. At the same time, the access frequency control unit 331 of the duplicate data storage device 33 pseudo-increments the number of accesses, so that the number of accesses to the duplicate data becomes equal to the number of accesses to the original data. In other words, the access frequency control unit 331 pseudo-conforms the access frequency to the duplicate data to the access frequency to the original data.

The data duplication control unit 332 controls the generation of the duplicate data. To be more detailed, the data duplication control unit 332 of the original data storage device 32 transmits the original data and a generation request of the duplicate data to the duplicate data storage device 33, in accordance with the storage device management rule. The data duplication control unit 332 of the duplicate data storage device 33 generates the duplicate data upon receipt of the generation request of the duplicate data.

The data priority control unit 333 determines the priority of each of the duplicate data. The term “data priority” means the priority order according to which the relevant data is to be used as substitute data for the original data. When the original data becomes inaccessible, the duplicate data of the first priority is selected as substitute data for the original data. Further, in case that the original data and the duplicate data of the first priority both become inaccessible, the duplicate data of the second priority is selected as substitute data for the original data.

The data storage location control unit 334 determines the storage location of the original data, or of the duplicate data. More specifically, the data storage location control unit 334 controls the storage location management table. The data storage location control unit 334 determines the data storage location based on the accessibility and the access frequency to the data storage unit 320, and the data priority. For example, the duplicate data of the second priority is less likely to be accessed than the duplicate data of the first priority. Accordingly, the data storage location control unit 334 may store the duplicate data of the second priority in one of the data storage units 320 having lower accessibility than another data storage units 320 in which the duplicate data of the first priority is stored.

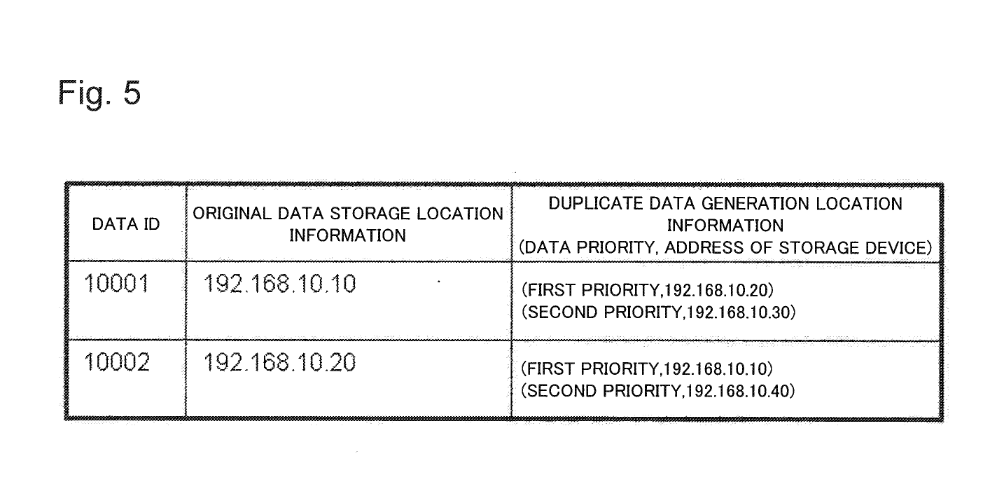

FIG. 5 is a table showing an example of the storage device management rule. The storage device management rule shown in FIG. 5 is related to the data having the data ID of “10001” and “10002”. Specifically, the storage device management rule shown in FIG. 5 indicates the correspondence among the data ID, the original data storage location information, and the duplicate data storage location information. The original data storage location information shown in FIG. 5 is the IP address of the storage device. The duplicate data storage location information shown in FIG. 5 is the set of the data priority and the IP address of the storage device.

The storage device management rule shown in FIG. 5 indicates, for example in the case of the data having the ID of “10001”, that the original data is stored at the address of “192.168.10.10”. Further, the storage device management rule shown in FIG. 5 indicates, with respect to the data having the ID of “10001”, the duplicate data of the first priority and the second priority are to be generated in the storage devices 3 located at the address of “192.168.10.20” and “192.168.10.30”, respectively. It is preferable that, as shown in FIG. 5, the management device control unit 220 determines the storage device management rule so as to respectively store the original data and each of the duplicate data in different storage devices 3.

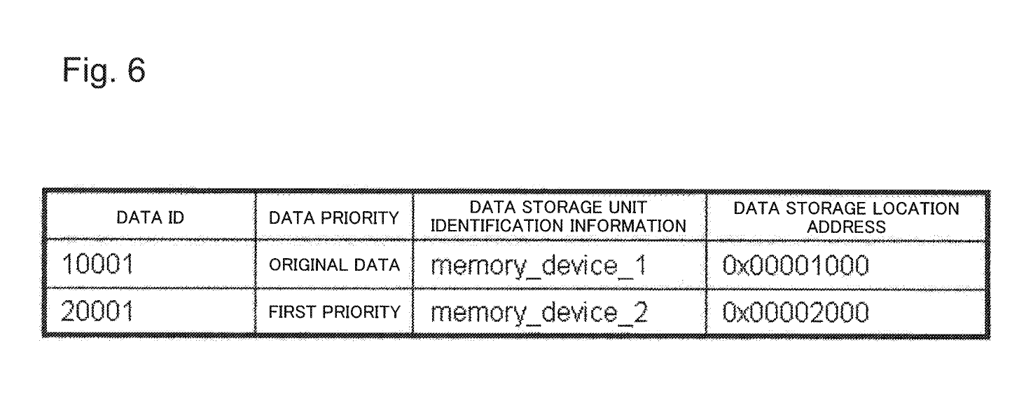

FIG. 6 is an example of the storage location management table. The storage location management table shown in FIG. 6 indicates the storage location of the data having the ID of “10001” and “20001”. More specifically, the storage location management table shown in FIG. 6 indicates the correspondence among the data ID, the data priority, the data storage unit identifying information, and the data storage location address.

The storage location management table shown in FIG. 6 indicates, for example, that the original data having the ID of “10001” is stored at the address “0x00001000” of the data storage unit 320 identified by “memory_device_{—}1”. Likewise, the data having the ID of “20001” and the first priority is stored at the address “0x00002000” of the data storage unit 320 identified by “memory_device_{—}2”.

The data storage unit 320 stores the data. The storage device 3 includes one or a plurality of data storage units 320. When the storage device 3 includes two or more data storage units 320, it is preferable that the data storage units 320 are different in accessibility from each other.

Hereunder, the operation of the storage system 1 will be described.

First, the process of storing the data in the storage device 3 will be described.

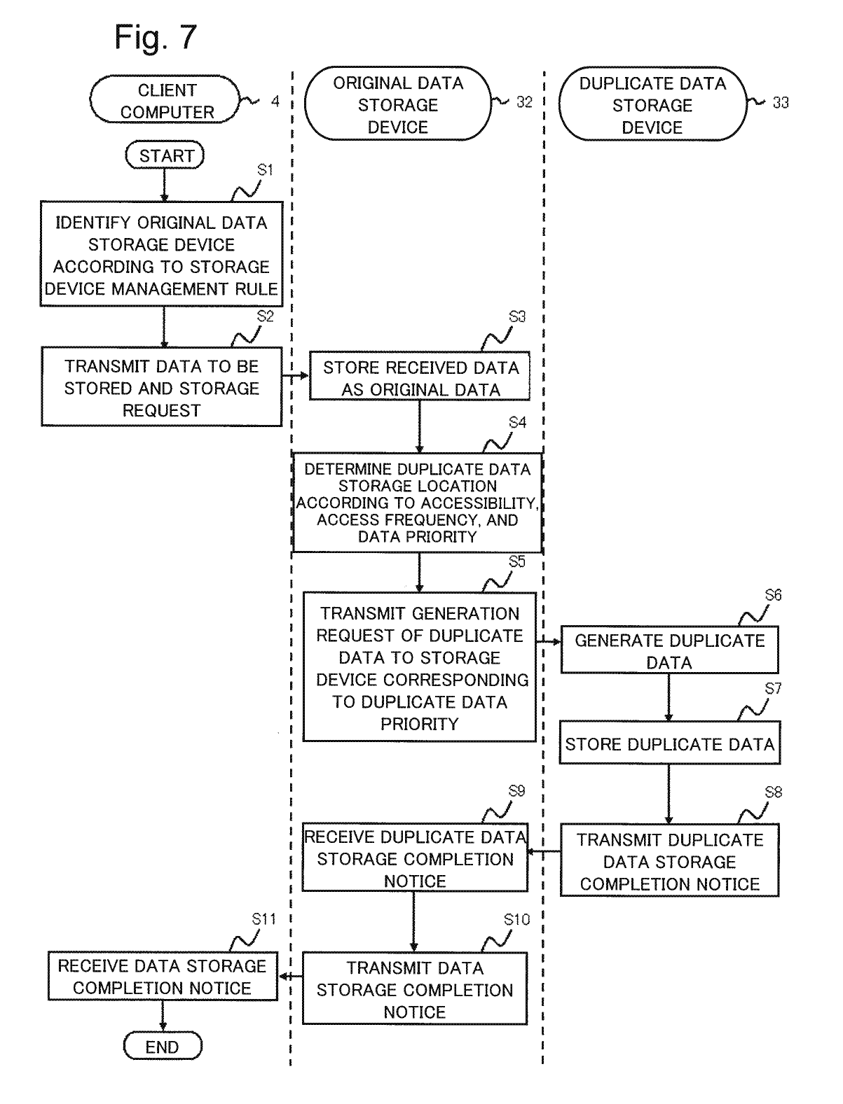

FIG. 7 is a flowchart showing an example of the data storing operation.

At Step S1, the client computer 4 identifies the original data storage device 32 in accordance with the storage device management rule. At Step S2, the client computer 4 transmits the storage request of the data to be stored, to the original data storage device 32 identified.

The storage device management unit 330 stores, upon receipt of the data to be stored and the data storage request from the client computer 4, the received data to be stored as original data (Step S3). Then the operation proceeds to Step S4.

When the data to be stored has a new data ID, the storage location control unit 334 may determine in advance the data storage unit 320 to be used as storage location. Alternatively, when the data to be stored has a new data ID, the storage location control unit 334 may determine the data storage unit 320 to be used as storage location, based on the capacity and the accessibility of the data storage unit 320.

At Step S4, the data priority control unit 333 determines the storage location of the duplicate data based on the access frequency, the accessibility, and the data priority. Then the operation proceeds to Step S5. Here, when the data to be stored has a new data ID, the data priority control unit 333 adds the data ID and the determined storage location of the duplicate data to the storage location management table. In contrast, when the data ID of the data to be stored is already registered in the storage location management table, the data priority control unit 333 determines the storage location of the duplicate data, based on the storage location management table.

At Step S5, the storage device management unit 330 transmits a generation request of the duplicate data to the duplicate data storage device 33 corresponding to the priority order of the duplicate data. At this point, the storage device management unit 330 transmits the original data together with the generation request of the duplicate data.

When the storage device management unit 330 of the duplicate data storage device 33 receives the original data and the generation request of the duplicate data, the data duplication control unit 332 of the duplicate data storage device 33 generates the duplicate data (Step S6). The data storage location control unit 334 then stores the duplicate data in the data storage unit 320 (Step S7). For this purpose, the data storage location control unit 334 determines the data storage unit 320 in which the duplicate data is to be stored, in accordance with the storage device management rule and the data storage location table.

At Step S8, the storage device management unit 330 of the duplicate data storage device 33 transmits a notice to the effect that the storage of the duplicate data has been completed, to the original data storage device 32. Then at Step S9, the storage device management unit 330 of the original data storage device 32 receives the duplicate data storage completion notice. At Step S10, the storage device management unit 330 of the original data storage device 32, transmits the duplicate data storage completion notice, to the client computer 4. At Step S11, the client computer 4 receives the duplicate data storage completion notice. Upon receipt of the duplicate data storage completion notice, the client computer 4 decides that the data storage operation has been completed.

Here, the storage device management unit 330 of the duplicate data storage device 33 may temporarily store the received original data in one of the data storage unit 320, and transmit the duplicate data storage completion notice, after which the storage device management unit 330 of the duplicate data storage device 33 may generate the duplicate data, so that the data storage location control unit 334 may store the duplicate data in the data storage unit 320.

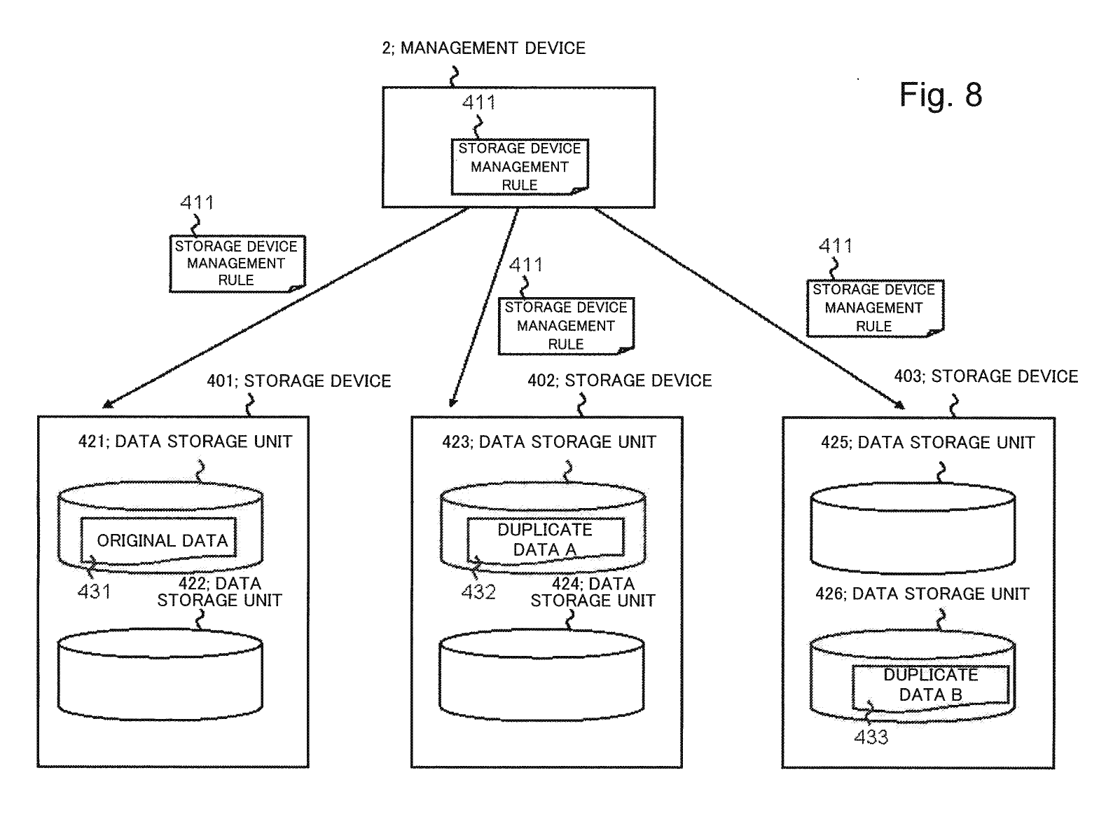

FIG. 8 is a block diagram showing an example of an arrangement of data storage in storage devices 401 to 403. In the example shown in FIG. 8, the storage device 401 includes a data storage unit 421 and a data storage unit 422. The storage device 402 includes a data storage unit 423 and a data storage unit 424. The storage device 403 includes a data storage unit 425 and a data storage unit 426. Now, the accessibility to the data storage units 421 to 426 will be assumed to be set as follows:

p421=p423=p425>p422=p424=p426

p421: accessibility of data storage unit 421

p422: accessibility of data storage unit 422

p423: accessibility of data storage unit 423

p424: accessibility of data storage unit 424

p425: accessibility of data storage unit 425

p426: accessibility of data storage unit 426

First, the management device 2 determines a storage device management rule 411. Then the management device 2 notifies the storage device management rule 411 to the storage devices 401 to 403. Here, it will be assumed that the storage device management rule 411 stipulates that the original data is to be stored in the storage device 401. In this case, the management device 2 transmits the original data 431 to the storage device 401, in accordance with the storage device management rule. The storage device 401 then stores the original data 431 in the data storage unit 421.

Further, the storage device 401 transmits the generation request of the duplicate data A 432 to the storage device 402, in accordance with the storage device management rule 411. The storage device 401 also transmits the generation request of the duplicate data B 433, lower in data priority than the duplicate data A 432, to the storage device 403 in accordance with the storage device management rule 411.

As described above, the accessibility of the data storage unit 421, the data storage unit 423, and the data storage unit 424 is set as follows:

p421=p423>p424

p421: accessibility of data storage unit 421

p423: accessibility of data storage unit 423

p424: accessibility of data storage unit 424

Accordingly, the storage device 402 stores the generated duplicate data A 432 in the data storage unit 423.

In addition, as described above the accessibility of the data storage unit 423, the data storage unit 425, and the data storage unit 426 is set as follows:

p423=p425>p426

p423: accessibility of data storage unit 423

p425: accessibility of data storage unit 425

p426: accessibility of data storage unit 426

Accordingly, the storage device 403 stores the duplicate data B 433 having lower data priority than the duplicate data A 432 in the data storage unit 426.

When data is stored in the storage system 1 according to this exemplary embodiment, as described above, the original data and the duplicate data thereof are respectively stored in different storage devices 3. Thus, the storage system 1 according to this exemplary embodiment can improve the data preservation reliability by possessing redundant data.

In addition, the storage device 3 according to this exemplary embodiment determines the data priority with respect to each of the duplicate data. Then the storage device 3 according to this exemplary embodiment determines the storage location of the duplicate data based on the priority order of the duplicate data. In this process, the storage device 3 according to this exemplary embodiment stores the duplicate data of the lower priority in the data storage unit 320 of the lower accessibility. This is because the duplicate data of the lower priority is less likely to be accessed by the client computer 4. In the storage system 1 according to this exemplary embodiment, therefore, client computer 4 the duplicate data less likely to be accessed by the client computer 4 is stored in the data storage unit of lower accessibility.

The data readout operation will now be described.

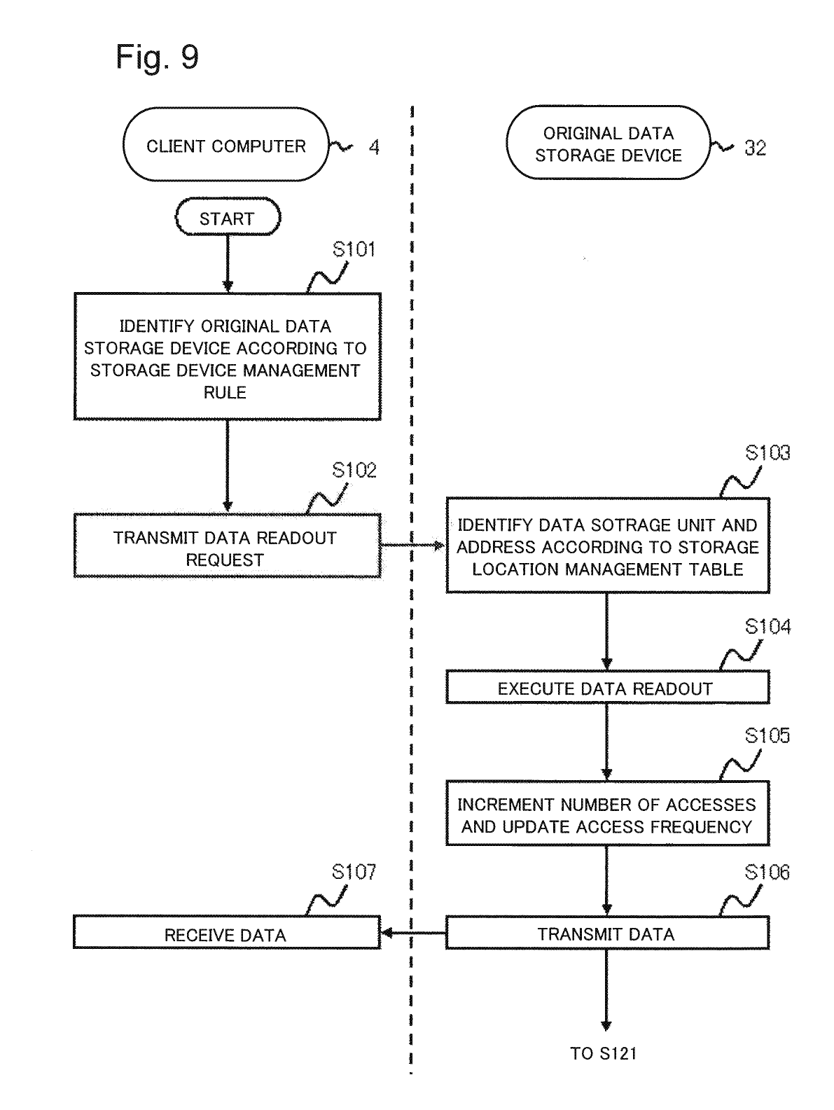

FIG. 9 is a flowchart showing an example of the data readout operation.

At Step S101, the client computer 4 identifies the original data storage device 32 in accordance with the storage device management rule. At Step S102, the client computer 4 transmits the data readout request to the original data storage device 32.

The original data storage device 32 identifies, upon receipt of the data readout request, the data storage unit 320 and the address based on the storage location management table (Step S103). At Step S104, the storage device management unit 330 executes the data readout.

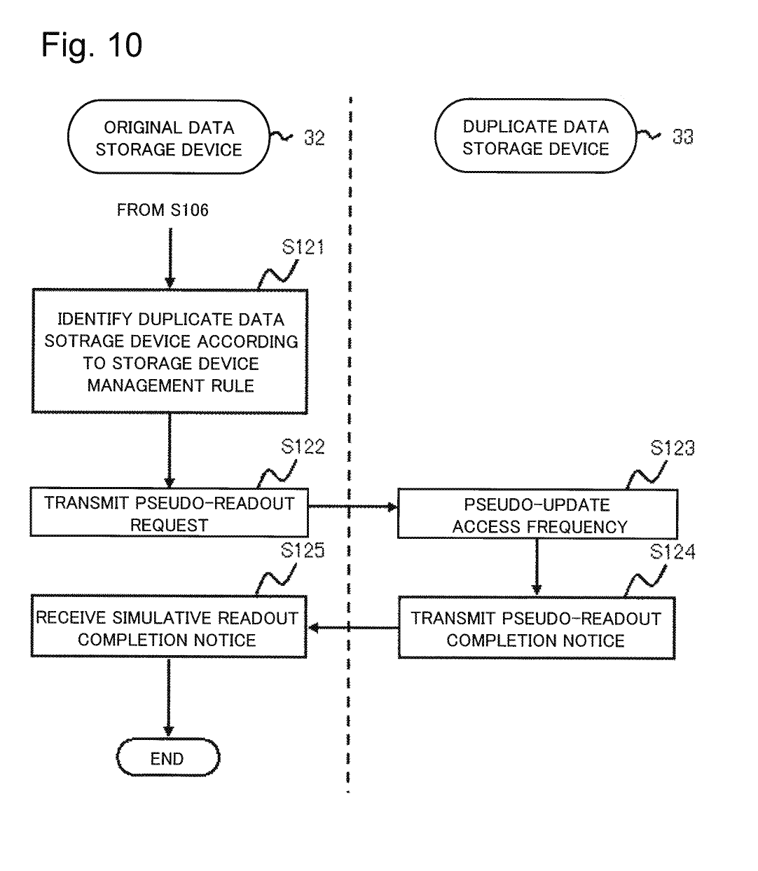

At Step S105, the access frequency control unit 331 increments the number of accesses to thereby update the access frequency. At Step S106, the storage device management unit 330 transmits the data to the client computer. Then the original data storage device 32 performs the operation of Step S121 shown in FIG. 10. At Step S107, the client computer 4 receives the data.

Hereunder, the operation performed by the duplicate data storage device 33 to pseudo-conforming the access frequency will be described.

FIG. 10 is a flowchart showing an example of the operation for pseudo-conforming the access frequency, performed by the duplicate data storage device 33.

At Step S121, the data storage location control unit 334 of the original data storage device 32 identifies the duplicate data storage device 33 in accordance with the storage device management rule.

At Step S122, the storage device management unit 330 of the original data storage device 32 transmits a simulative reading request to the duplicate data storage device 33.

When the storage device management unit 330 of the duplicate data storage device 33 receives the simulative reading request, the access frequency control unit 331 of the duplicate data storage device 33 pseudo-updates the access frequency at Step S123. To be more detailed, the duplicate data storage device 33 does not read out the data, but increments the number of accesses to the duplicate data. Then the access frequency control unit 331 of the duplicate data storage device 33 updates the access frequency to the duplicate data. As a result, the duplicate data storage device 33 can pseudo-conform the access frequency to the duplicate data to the access frequency to the original data. Then the operation proceeds to Step S124.

At Step S124, the storage device management unit 330 of the duplicate data storage device 33 transmits the simulative readout completion notice to the original data storage device 32. At Step S125, the storage device management unit 330 of the original data storage device 32 receives the simulative readout completion notice.

In the storage system 1 according to this exemplary embodiment, as described above, the access frequency to the original data and the access frequency to the duplicate data are pseudo-conformed with each other. Here, the storage device 3 according to this exemplary embodiment updates the data storage location according to the access frequency. Accordingly, when the access frequency to the original data is lowered, the original data is transferred to the data storage unit 320 having lower accessibility. Further, because of the simulative conformation of the access frequency, the storage device 3 according to this exemplary embodiment transfers the duplicate data to the data storage unit 320 having lower accessibility, in parallel to the decrease in access frequency to the original data. Therefore, the storage device 3 according to this exemplary embodiment can store both of the original data and the duplicate data in the appropriate data storage unit 320, according to the access frequency.

Hereunder, an operation to decide whether the storage device 3 has failed will be described.

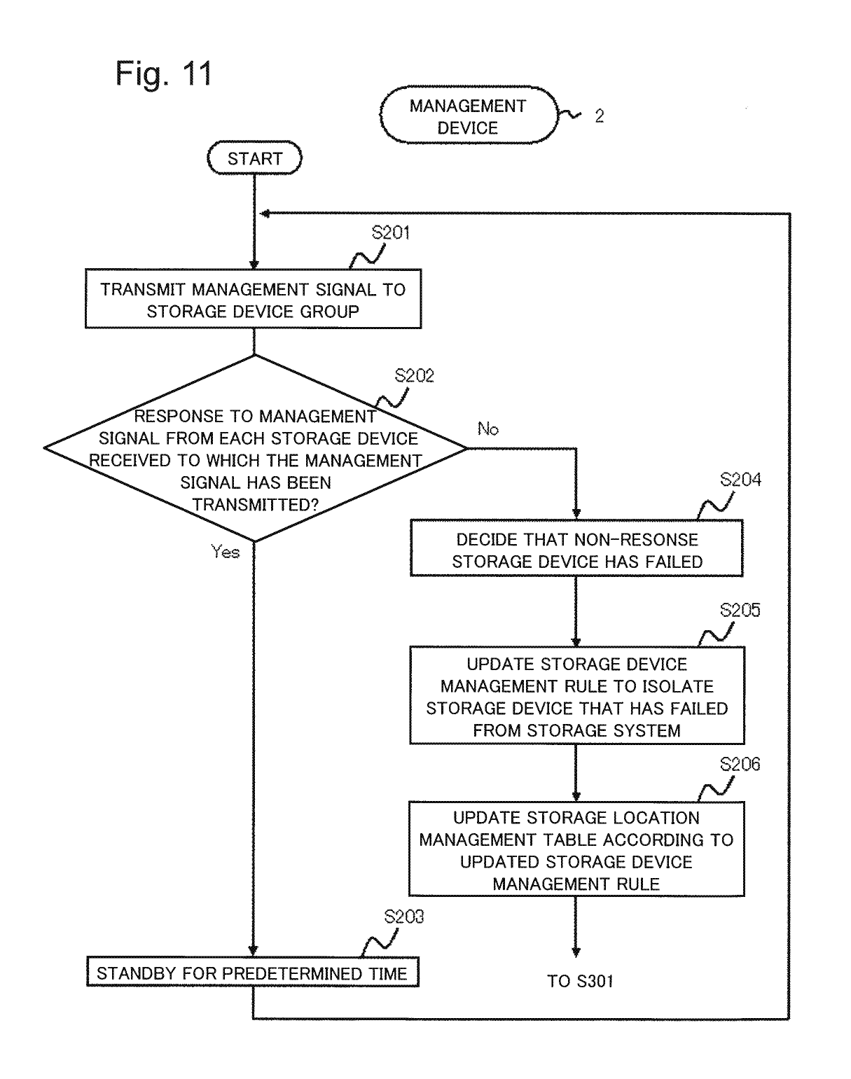

FIG. 11 is a flowchart showing an example of the decision process on whether the storage device 3 has failed.

At Step S201, the management device control unit 220 transmits a management signal to the storage device group 31. The management signal refers to a signal transmitted to check the operational status of the storage device 3.

At Step S202, the management device control unit 220 decides whether a response to the management signal has been received from each of the storage devices to which the management signal has been transmitted. Upon receipt of the response to the management signal (Yes at Step S202), the management device control unit 220 decides that the corresponding storage device 3 is normally operating, and then proceeds to Step S203. In contrast, in the case where the response signal to the management signal is not received (No at Step S202), the operation proceeds to Step S204.

At Step S203, the management device control unit 220 stands by for a predetermined time (for example, 1 minute), and then resumes the operation from Step S201.

In contrast, at Step S204 the management device control unit 220 decides that the storage device 3 that has not responded has a malfunction. Then at Step S205, the management device control unit 220 updates the storage device management rule so as to isolate the storage device 3 that has failed from the storage system 1. In other words, the management device 2 excludes the storage device 3 that has failed from the storage location of the original data and the duplicate data.

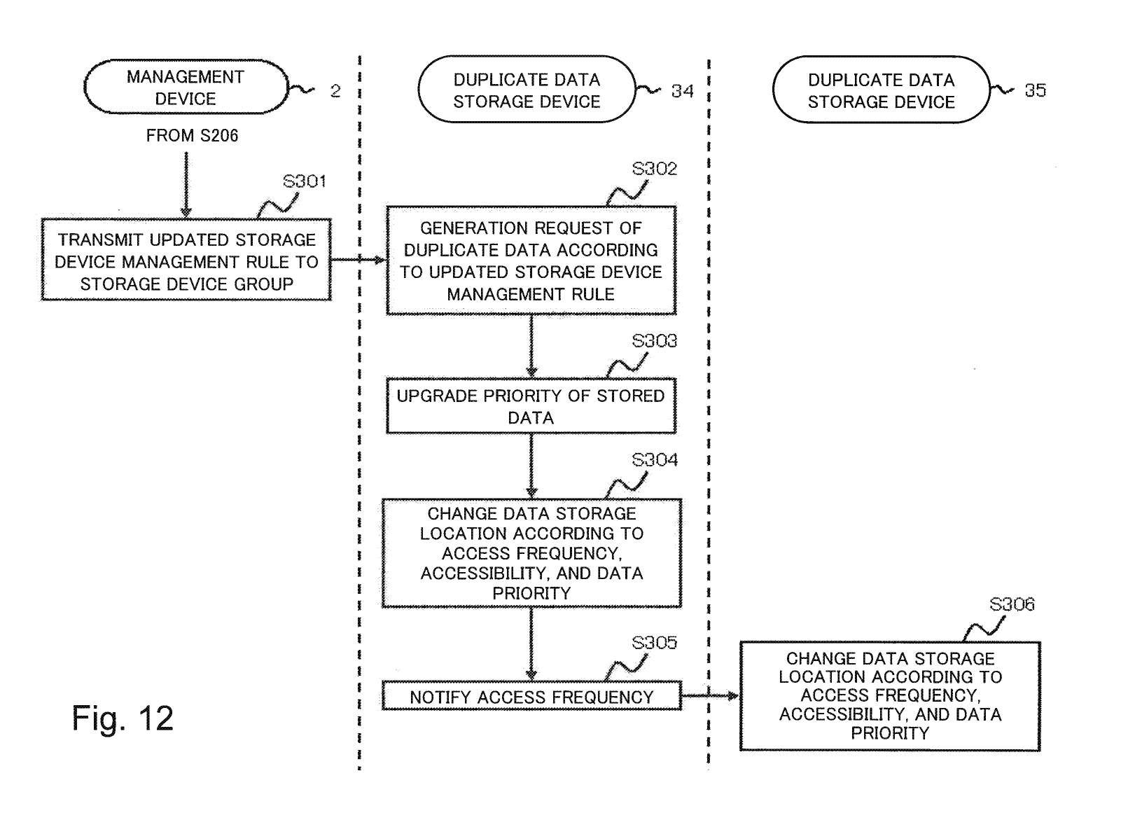

At Step S206, the management device control unit 220 updates the storage location management table based on the updated storage device management rule. Then the operation proceeds to Step S301 shown in FIG. 12.

An operation performed when the data storage device 3 has failed will be described hereunder. When one of the data storage devices 3 has failed, the data priority control unit 333 of the normally working storage device 3 changes the data priority of the duplicate data. Then the data storage location control unit 334 of the normally working storage device 3 changes the data storage location based on the access frequency, the updated data priority, and the accessibility of the data storage unit 320. Such operation will be described in further details with reference to FIG. 12.

FIG. 12 is a flowchart showing an example of an operation performed in case of failure of the original data storage device 32. In the description given hereunder, it will be assumed that the duplicate data storage device 34 and the duplicate data storage device 35 each store the duplicate data of the data the access to which has been disabled. In addition, it will be assumed that the data priority of the duplicate data stored in the duplicate data storage device 34 is higher than that of the duplicate data stored in the duplicate data storage device 35.

At Step S301, the management device control unit 220 transmits the updated storage device management rule to the storage device group 31.

The storage device management unit 330 of the duplicate data storage device 34 transmits, upon receipt of the updated storage device management rule, the generation request of the duplicate data to a predetermined storage device 3, in accordance with the updated storage device management rule (Step S302). For example, the storage device management unit 330 of the duplicate data storage device 34 may request the duplicate data storage device 35 to generate new duplicate data. Alternatively, the storage device management unit 330 of the duplicate data storage device 34 may request one of the storage devices 3 other than the mentioned duplicate data storage device 35 to generate the new duplicate data.

At Step S303, the data priority control unit 333 of the duplicate data storage device 34 upgrades the priority of the data stored therein. In this case, since the storage device storing the original data has failed, the data priority control unit 333 of the duplicate data storage device 34 promotes the data stored therein to the original data.

At Step S304, the data storage location control unit 334 of the duplicate data storage device 34 changes the data storage location based on the access frequency, the accessibility, and the data priority.

At Step S305, the storage device management unit 330 of the duplicate data storage device 34 notifies the access frequency to the duplicate data storage device 35.

The storage device management unit 330 of the duplicate data storage device 35 receives the information of the access frequency, and the data storage location control unit 334 of the duplicate data storage device 35 changes the data storage location based on the access frequency, the accessibility, and the data priority (Step S306).

In the case where the storage device 3 storing the duplicate data has failed, the same operation is performed. More specifically, first the management device 2 excludes the storage device 3 that has failed from the data storage location. Then the storage device 3 that is working compares the data priority with the data stored in the storage device 3 that has failed, and upgrades the data priority of the data that has the lower priority. Further, the working storage device 3 generates the duplicate data so that the number of data agrees with the number before the failure. Further details of the process are the same as the process according to Step S301 to Step S305 shown in FIG. 12, and therefore the description will not be repeated.

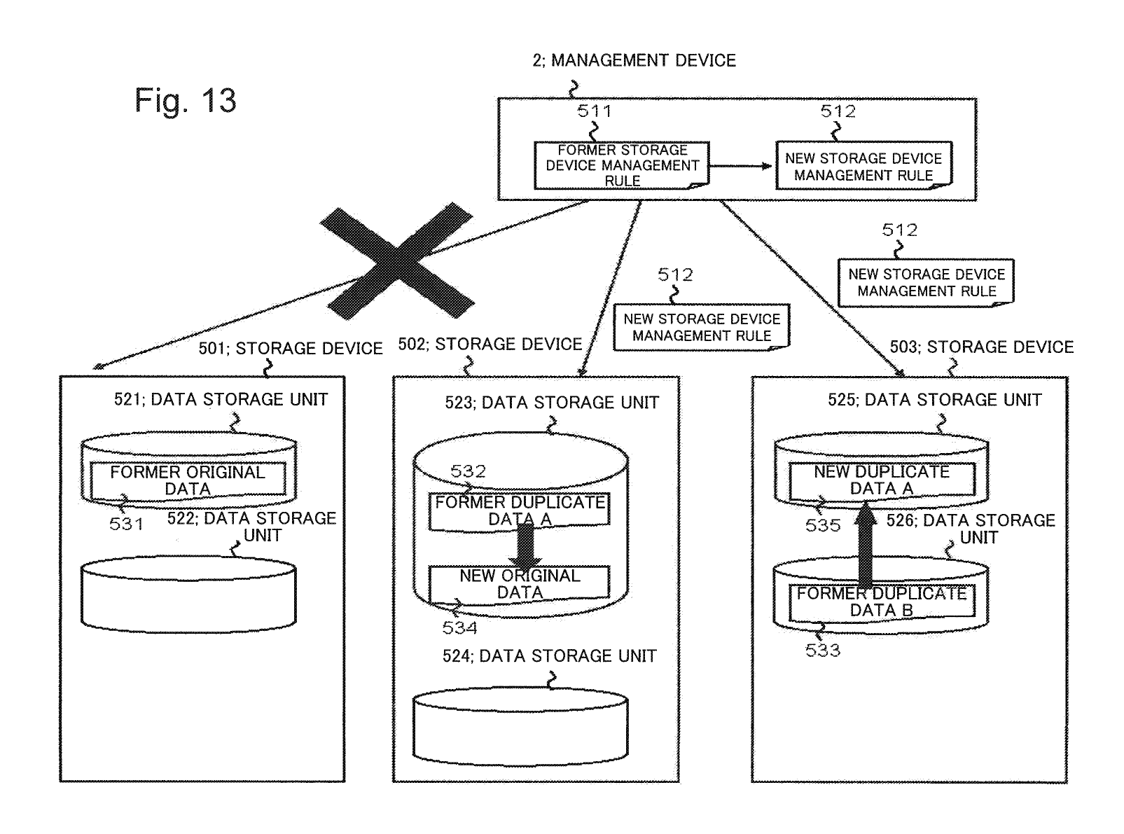

FIG. 13 is a flowchart showing an example of an operation performed in case of failure of the storage device 501. In the example shown in FIG. 13, a storage device 501 includes a data storage unit 521 and a data storage unit 522. A storage device 502 includes a data storage unit 523 and a data storage unit 524. A storage device 503 includes a data storage unit 525 and a data storage unit 526. It will be assumed that the accessibility of the data storage units 521 to 526 is set as follows:

p521=p523=P525>p522=p524=p526

p521: accessibility of data storage unit 521

p522: accessibility of data storage unit 522

p523: accessibility of data storage unit 523

p524: accessibility of data storage unit 524

p525: accessibility of data storage unit 525

p526: accessibility of data storage unit 526

It will be assumed that before the storage device 501 fails, the storage device 501 stores former original data 531 in the data storage unit 521, that the storage device 502 stores former duplicate data A 532 in the data storage unit 523, and that the storage device 503 stores former duplicate data B 533 in the data storage unit 534. In addition, it will be assumed that the former duplicate data A 532 is higher in data priority than the former duplicate data B 533.

Now, when the management device 2 decides that the storage device 501 has failed, the management device 2 updates a former storage management rule 511 to a new storage management rule 512, so as to exclude the storage device 501 from the data storage location. Then the management device 2 notifies the new storage device management rule 512 to the storage device 502 and the storage device 503.

The storage device 502 promotes the former duplicate data 532 to new original data 534, in accordance with the new storage device management rule 512, and requests the storage device 503 to promote the former duplicate data B 533 to new duplicate data A 535.

The storage device 503 promotes the former duplicate data B 533 to the new duplicate data A 535. The storage device 503 then determines the storage location of the new duplicate data A. It is preferable that the storage device 503 stores the new duplicate data A 535 in the storage location of equivalent accessibility to the storage location of the former duplicate data A 532. As mentioned above, the accessibility of the data storage unit 523 and the accessibility of the data storage unit 525 are equivalent. Therefore, the storage device 503 stores the new duplicate data A 535 in the data storage unit 525.

The storage device 503 has promoted the former duplicate data B 533 to the new duplicate data A 535. Accordingly, the storage device 502 requests a predetermined storage device 3 to generate new duplicate data B based on the new storage device management rule 512.

As described above, when any of the storage devices 3 fails, the storage system 1 according to this exemplary embodiment excludes the storage device 3 that has failed from the data storage location. Then the storage device 3 according to this exemplary embodiment changes the data priority so as to substitute for the data stored in the storage device 3 that has failed. Further, the storage device 3 according to this exemplary embodiment generates the new duplicate data so that the number of data agrees with the number before the failure. Therefore, the storage system 1 according to this exemplary embodiment can maintain the data preservation reliability, even though any of the storage devices 3 fails.

An operation of the client computer 4 performed when the storage device 3 has failed will be described hereunder.

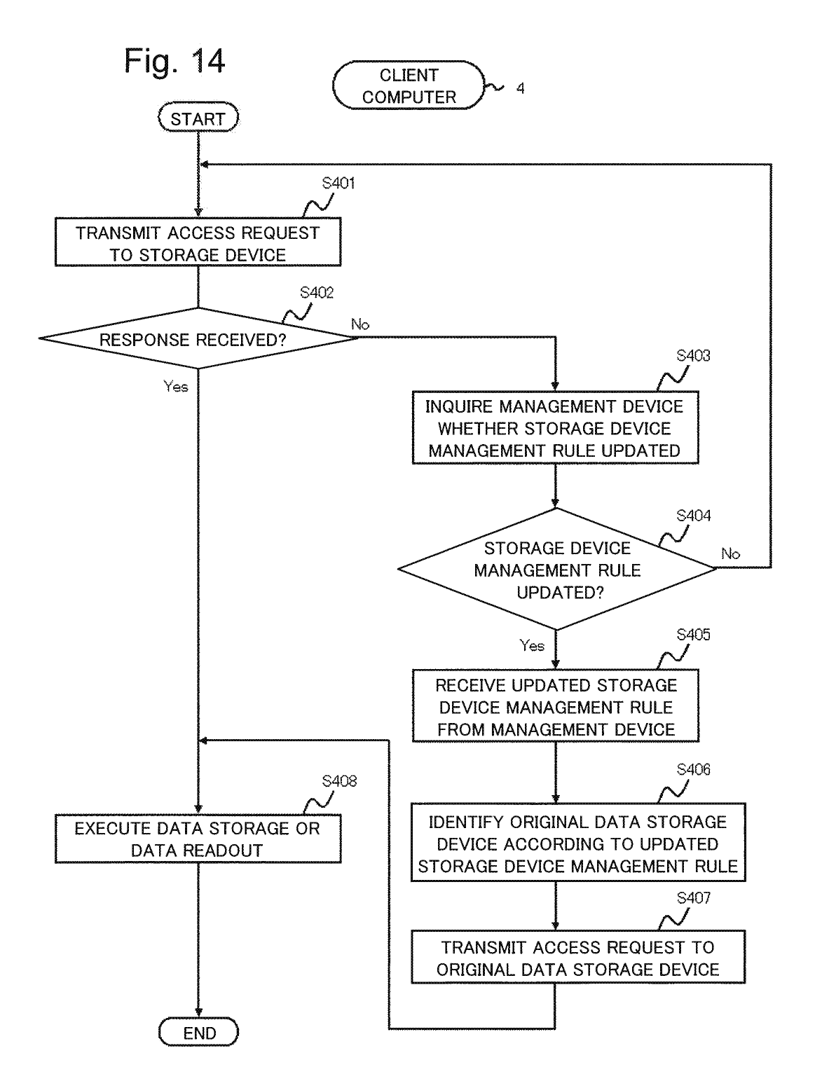

FIG. 14 is a flowchart showing an example of an operation performed by the client computer 4 when the storage device 3 has failed.

At Step S401, the client computer 4 transmits an access request to the storage device 3. To be more detailed, the client computer 4 identifies the original data storage device 32 in accordance with the storage device management rule. Then the client computer 4 transmits the access request to the original data storage device 32.

At Step S402, the client computer 4 decides whether a response has been received. In the case where the response has been received (Yes at Step S402), the operation proceeds to Step S408. In the case where the response has not been received (No at Step S402), the operation proceeds to Step S403.

At Step S403, the client computer 4 inquires the management device 2 whether the storage device management rule has been updated. At Step S404, the client computer 4 decides whether the storage device management rule has been updated. In the case where the storage device management rule has been updated (Yes at Step S404), the operation proceeds to Step S405. In the case where the storage device management rule has not been updated (No at Step S404), the operation is resumed from Step S401.

At Step S405, the client computer 4 receives the updated storage device management rule from the management device 2.

At Step S406, the client computer 4 identifies the original data storage device 32, in accordance with the updated storage device management rule.

At Step S407, the client computer 4 transmits the access request to the original data storage device 32, and proceeds to Step S408.

At Step S408, the client computer 4 stores the data, or reads out the data.

As mentioned above, the original data storage device 32 requests the duplicate data storage device 33 to generate the duplicate data. At this point, the original data storage device 32 sets the data priority with respect to the duplicate data. Then the storage devices 3 each determine the data storage location based on the access frequency and the data priority. Therefore, the storage system 1 according to this exemplary embodiment prevents the frequently accessed data from being stored in the data storage unit 320 of lower accessibility. Thus, the storage system 1 according to this exemplary embodiment contributes to securing high efficiency in accessing the data.

In the storage system 1 according to this exemplary embodiment, the data storage location is determined based on the access frequency to the data and the accessibility of the data storage unit 320. Therefore, the storage system 1 according to this exemplary embodiment contributes to suppressing useless consumption of the resource of the storage device 3.

In the storage system 1 according to this exemplary embodiment, the access to the data by the client computer 4 can be secured even when any of the storage devices 3 has failed. Therefore, the storage system 1 according to this exemplary embodiment contributes to secure the convenience in accessing the data.

### Second Exemplary Embodiment

Hereunder, a second exemplary embodiment will be described in details.

In this exemplary embodiment, original data storage location information and duplicate data storage location information are shared by the client computer and the storage device. In the description of this exemplary embodiment, the same aspects as those of the first exemplary embodiment will be omitted. In addition, the same constituents as those of the first exemplary embodiment will be given the same numeral, and the description thereof will not be repeated.

The management device control unit 220 according to this exemplary embodiment determines the original data storage device 32 through comparison between a digest value of the data ID and a predetermined value range allocated in advance to the original data storage device 32. The management device control unit 220 may calculate the digest value of the data ID using a hash function or the like. In this exemplary embodiment, the management device control unit 220 compares between the digest value of the data ID and the predetermined value range allocated in advance to the original data storage device 32. Then the management device control unit 220 selects the original data storage device 32 according to the comparison result.

Alternatively, the management device control unit 220 may determine the duplicate data storage device 33 according to the result of comparison between the digest value of the data ID and a predetermined value range allocated in advance to the duplicate data storage device 33.

Then the management device control unit 220 notifies the digest value of the data ID and the predetermined value range allocated to each of the storage devices 3, to the storage devices 3 and the client computers 4.

As described above, in the storage system 1 according to this exemplary embodiment the data storage location is determined based on the digest value of the data ID and the predetermined value range allocated to each of the storage devices 3. The information necessary for determining the data storage location is shared by the storage devices 3 and the client computers 4. In the storage system 1 according to this exemplary embodiment, therefore, the inquiries to the management device 2 for determining the data storage location can be suppressed. Therefore, in the storage system 1 according to this exemplary embodiment, the load on the management device 2 can be distributed to each of the client computers 4. Consequently, the storage system 1 according to this exemplary embodiment further contributes to securing the convenience in accessing the data.

In the foregoing exemplary embodiments, the storage devices 3, the management device 2, and the client computers 4 are connected to each other via the network 5. However, the communication among the storage devices 3 may be realized via a network other than the network 5. Alternatively, the storage devices 3, the management device 2, and the client computers 4 may be respectively connected via different networks.

In the foregoing exemplary embodiments, the storage system 1 includes a single management device 2. However, the storage system 1 may include two or more management devices 2. For example, when one of the management devices 2 has failed, another management device 2 may execute the operation on behalf of the management device 2 that has failed. Thus, the management device 2 may have a redundant structure in the storage system 1.

In the foregoing exemplary embodiments, further, the management device 2 and the storage devices 3 are set up as separate units. However, a unit that serves as the management device 2 may be selected out of the storage device group 31. In this case, when the management device 2 has failed, a unit that serves as the management device 2 may be newly selected out of the storage device group 31.

Further, in the foregoing exemplary embodiments, the original data storage device 32 transmits the generation request of the duplicate data to the predetermined duplicate data storage device 33. However, the original data storage device 32 may duplicate the data and transmit the duplicate data to the predetermined duplicate data storage device 33.

It is a matter of course that the storage device 3 may serve as the original data storage device 32 or the duplicate data storage device 33, depending on the data. In other words, the storage device 3 may serve as the original data storage device 32 with respect to certain data, and may serve as the duplicate data storage device 33 with respect to another data.

A part or the whole of the foregoing exemplary embodiments may be described as the following Aspects, without limitation thereto.

[Aspect 1] The storage system according to the first aspect.

[Aspect 2] The storage system according to Aspect 1,

further including a data priority control unit that determines data priority of each of the duplicate data, wherein

the data storage location control unit determines the respective storage locations of the original data and the duplicate data, based on the accessibility, the access frequency, and the data priority.

[Aspect 3] The storage system according to Aspect 2,

wherein, in a case where any of the storage devices has failed, the data priority control unit changes the data priority, and

the storage location control unit changes the data storage location based on the access frequency, the changed data priority, and the accessibility.

[Aspect 4] The storage system according to Aspect 2 or 3, in which the storage device includes a storage device memory unit containing a storage location management table in which the data ID, the data priority, and data storage location identifying information are associated with one another.

[Aspect 5] The storage system according to any one of Aspects 1 to 4,

wherein in a case where the original data is read out from the data storage unit of the first storage device,

the access frequency control unit of the second storage device changes the access frequency to the duplicate data so as to agree with the access frequency of the original data.

[Aspect 6] The storage system according to any one of Aspects 1 to 5, further including two or more of the second storage devices.

[Aspect 7] The storage device according to the second aspect.

[Aspect 8] The storage device according to Aspect 7, further including a data priority control unit that determines data priority of each of the duplicate data, wherein

the data storage location control unit determines the respective storage locations of the original data and the duplicate data, based on the accessibility, the access frequency, and the data priority.

[Aspect 9] The storage device according to Aspect 8,

wherein, in a case where any of the storage devices has failed, the data priority control unit changes the data priority, and

the storage location control unit changes the data storage location based on the access frequency, the changed data priority, and the accessibility.

[Aspect 10] The storage device according to Aspect 8 or 9, in which the storage device includes a storage device memory unit containing a storage location management table in which the data ID, the data priority, and data storage location identifying information are associated with one another.

[Aspect 11] The storage device according to any one of Aspects 7 to 10, in which, when the data storage unit stores the duplicate data, the access frequency control unit changes the access frequency to the duplicate data so as to agree with the access frequency of the original data.

[Aspect 12] The storage device control method according to the third aspect.

[Aspect 13] The storage device control method according to Aspect 10, further including a data priority control step of determining the priority order of each of the duplicate data, and the data storage location control step of determining the storage location of the original data or the duplicate data based on the accessibility, the access frequency, and the data priority.

[Aspect 14] The storage device control method according to Aspect 13, in which, in the case where another storage device has failed, the data priority is changed in the data priority controlstep, and the data storage location is changed based on the access frequency, the changed data priority, and the accessibility, in the storage location control step.

[Aspect 15] The storage device control method according to any one of Aspects 12 to 14, in which, when the data storage unit stores the duplicate data, the access frequency control unit changes the access frequency to the duplicate data so as to agree with the access frequency of the original data.

[Aspect 16] The storage device control program according to the fourth aspect.

[Aspect 17] The storage device control program according to Aspect 16, further including executing a data priority control process for determining the data priority of each of the duplicate data, and determining the storage location of the original data or the duplicate data based on the accessibility, the access frequency, and the data priority, in the storage location the data storage location control process.

[Aspect 18] The storage device control program according to Aspect 17, in which, in the case where another storage device has failed, the data priority is changed in the data priority control process, and the data storage location is changed based on the access frequency, the changed data priority, and the accessibility, in the storage location control process.

[Aspect 19] The storage device control program according to any one of Aspects 16 to 18, in which, when the duplicate data is stored in the access frequency control process, the access frequency to the duplicate data is changed so as to agree with the access frequency of the original data.

[Aspect 20] The management device according to the fifth aspect.

[Aspect 21] The management device according to Aspect 20, in which the management device control unit calculates the digest value of the data ID, and determines the first storage device based on a result of comparison between the digest value and a predetermined value range allocated in advance to each of the first storage devices.

[Aspect 22] The management device according to Aspect 20 or 21, in which the management device control unit determines the second storage device based on a result of comparison between the digest value and a predetermined value range allocated in advance to each of the second storage devices.

[Aspect 23] The management device control method according to the sixth aspect.

[Aspect 24] The management device control method according to Aspect 23, in the management device control step, calculating the digest value of the data ID, and determining the first storage device based on a result of comparison between the digest value and a predetermined value range allocated in advance to each of the first storage devices.

[Aspect 25] The management device control method according to Aspect 23 or 24, in the management device control step, determining the second storage device based on a result of comparison between the digest value and a predetermined value range allocated in advance to each of the second storage devices.

[Aspect 26] The management device control program according to the seventh aspect.

[Aspect 27] The management device control method according to Aspect 26, in the management device control process, calculating the digest value of the data ID, and determining the first storage device based on a result of comparison between the digest value and a predetermined value range allocated in advance to each of the first storage devices.

[Aspect 28] The management device control program according to Aspect 26 or 27, in the management device control process, determining the second storage device based on a result of comparison between the digest value and a predetermined value range allocated in advance to each of the second storage devices.

The disclosure of the above-cited Patent Literatures is incorporated hereinto by reference. The exemplary embodiments and examples may be modified or adjusted, within the scope of the entire disclosure of the present invention including the appended claims, and based on the essential technical idea. The constituents and elements of the exemplary embodiments and examples, the claims, and the drawings may be selectively combined in various manners within the scope of the claims of the present invention. The present invention encompasses various modifications and amendments that persons skilled in the art may reach based on the entire disclosure (including the claims) and the technical idea of the present invention. Regarding the numerical value ranges cited herein, in particular, it is to be construed that a value or a minor range included in the value range is specifically expressed, despite such value or range not being apparently indicated.

### REFERENCE SIGNS LIST

1, 100 Storage system
2 Management device
3, 401 to 403, 501 to 503 Storage device
4 Client computer
5 Network
31 Storage device group
32 Original data storage device
33 to 35 Duplicate data storage device
101 Management device
102 First storage device
103 Second storage device
111, 320, 421 to 426, 521 to 526 Data storage unit
112, 332 Data duplication control unit
113, 331 Access frequency control unit
114, 334 Data storage location control unit
210 Management device storage unit
220 Management device control unit
310 Storage device storage unit
333 Data rank control unit
411 Storage device management rule
431 Original data
432 Duplicate data A
433 Duplicate data B
511 Former storage device management rule
512 New storage device management rule
531 Former original data
532 Former duplicate data A
533 Former duplicate data B
534 New original data
535 New duplicate data A

What is claimed is:

1. A storage system comprising:
two or more storage devices that store original data and duplicate data of the original data; and
a management device that identifies a first the storage device that stores the original data and a second the storage device that stores the duplicate data,
wherein the storage devices each is provided with:
two or more data storage units with different in accessibility from each other;
a data duplication control unit that controls generation of the duplicate data;
an access frequency control unit that pseudo-conforms access frequency to the duplicate data to access frequency to the original data; and
a data storage location control unit that determines storage locations of the original data and the duplicate data based on the access frequency and the accessibility.

2. The storage system according to claim 1,
further comprising a data priority control unit that determines data priority of each of the duplicate data, wherein
the data storage location control unit determines the respective storage locations of the original data and the duplicate data, based on the accessibility, the access frequency, and the data priority.

3. The storage system according to claim 2,
wherein, in a case where any of the storage devices has failed, the data priority control unit changes the data priority, and
the storage location control unit changes the data storage location based on the access frequency, the changed data priority, and the accessibility.

4. The storage system according to claim 1
wherein in a case where the original data is read out from the data storage unit of the first storage device,
the access frequency control unit of the second storage device changes the access frequency to the duplicate data so as to agree with the access frequency of the original data.

5. A storage device comprising:
two or more data storage units different in accessibility from each other;
a data duplication control unit that controls duplication of data;
an access frequency control unit that pseudo-conforms access frequency to the duplicate data to access frequency to the original data; and
a data storage location control unit that determines respective storage locations of the original data and the duplicate data of the original data based on the access frequency and the accessibility.

6. A control method of a storage device including two or more data storage units different in accessibility from each other, the method comprising:
a data duplication control step;
an access frequency control step of pseudo-conforming access frequency to the duplicate data to access frequency to the original data; and
a data storage location control step of determining respective storage locations of the original data and the duplicate data of the original data based on the access frequency and the accessibility.

7. (canceled)

8. (canceled)

9. (canceled)

10. (canceled)

11. The storage system according to any one of claim 2,
wherein in a case where the original data is read out from the data storage unit of the first storage device,
the access frequency control unit of the second storage device changes the access frequency to the duplicate data so as to agree with the access frequency of the original data.

12. The storage system according to any one of claim 3,
wherein in a case where the original data is read out from the data storage unit of the first storage device,
the access frequency control unit of the second storage device changes the access frequency to the duplicate data so as to agree with the access frequency of the original data.
